(19) United States
(12) Patent Application Publication
(10) Pub. No.: US 2024/0101783 A1
(43) Pub. Date: Mar. 28, 2024

(54) PROCESS FOR RECOVERING RAW MATERIALS FROM POLYURETHANE FOAMS

(71) Applicant: Covestro Deutschland AG, Leverkusen (DE)

(72) Inventors: Sebastian Pohl, Langenfeld (DE); Friedhelm Steffens, Leverkusen (DE)

(21) Appl. No.: 18/256,965

(22) PCT Filed: Dec. 13, 2021
(86) PCT No.: PCT/EP2021/085405

§ 371 Date: Jun. 12, 2023

(30) Foreign Application Priority Data
Dec. 14, 2020 (EP) 20213874.9
Oct. 20, 2021 (EP) 21203752.7

(51) Int. Cl. C08J 11/26; C08J 11/24

(52) U.S. Cl. CPC C08J 11/26; C08J 11/24; C08J 2375/04

(57) ABSTRACT

The present invention relates to a process for recovering raw materials from a polyurethane foam, comprising step (A), the providing of a polyurethane foam based on an isocyanate component and a polyol component, wherein the polyurethane foam comprises a cell structure containing one or more volatile accompanying substances, namely a component X selected from the group consisting of oxygen, a blowing agent, a disinfectant and a mixture of two or more of the above, wherein component X comprises at least oxygen, step (B), the chemolysis of the polyurethane foam with a chemolysis reagent, wherein the polyurethane foam is degassed before being contacted with the chemolysis reagent, wherein at least oxygen, but preferably all constituents of component X or any gaseous breakdown products thereof that have formed are removed from the chemolysis apparatus in gaseous form via a gas removal device at a pressure of not more than 960 mbar(abs.) and a temperature of not more than 120° C., so as to obtain a degassed polyurethane foam, followed by the reaction of the degassed polyurethane foam with the chemolysis reagent in the presence of a catalyst in an inert gas atmosphere and the workup of the product mixture obtained by the chemolysis, step (C), the obtaining of at least one polyol, and optionally step (D), the obtaining of at least one amine corresponding to an isocyanate of the isocyanate component.

The present invention relates to a method of recovering raw materials from a polyurethane foam, comprising step (A), the providing of a polyurethane foam based on an isocyanate component and a polyol component, wherein the polyurethane foam has a cell structure containing one or more volatile accompanying substances, namely a component X selected from the group consisting of oxygen, a blowing agent, a disinfectant and a mixture of two or more of the aforementioned accompanying substances, wherein component X comprises at least oxygen, step (B), the chemolysis of the polyurethane foam with a chemolysis reagent, wherein the polyurethane foam is degassed before being contacted with the chemolysis reagent, wherein at least oxygen, but preferably all constituents of component X or any gaseous decomposition products thereof that may have formed, are removed from the chemolysis apparatus at a pressure of not more than 960 mbar_{(abs.)} and a temperature of not more than 120° C. in gaseous form via a gas removal device, so as to obtain a degassed polyurethane foam, followed by reaction of the degassed polyurethane foam with the chemolysis reagent in the presence of a catalyst in an inert gas atmosphere and the workup of the product mixture obtained by the chemolysis, step (C), the recovering of the at least one polyol, and optionally step (D), the recovering of at least one amine corresponding to an isocyanate of the isocyanate component.

Polyurethane foams enjoy a variety of applications in industry and in everyday life. They are typically divided into rigid foams (which are used as insulation materials, for example) and flexible foams (which are used in cushioned furniture manufacture, for example). What is common to all polyurethane foams, in spite of such differences, is the basic polyurethane structure which is formed by the polyaddition reaction of a polyfunctional isocyanate and of a polyol and which, in the case, for example, of a polyurethane based on a diisocyanate O═C═N—R—N═C═O and a diol H—O—R′—O—H (where R and R′ denote organic radicals), can be represented as

˜˜˜[O—R′—O—(O═C)—HN—R—NH—(C═O)]˜˜˜.

It is the great economic success of the polyurethane foams that means that there are large quantities of polyurethane waste arising (from old mattresses or seated furniture, for example) that must be sent for rational use. The mode of reuse that is the easiest to implement technically is that of incineration, with the heat of combustion released being utilized for other processes, examples being industrial processes. However, this does not allow the raw materials loops to be completed. Another mode of reuse is that referred to as “physical recycling”, which sees polyurethane wastes mechanically comminuted and used in the manufacture of new products. The obvious limits to this mode of recycling mean that there has been no lack of attempts to recover the raw materials underlying polyurethane production by rebreaking the polyurethane linkages (referred to as “chemical recycling”). These raw materials to be won back comprise primarily polyols (i.e., in the example above, H—O—R′—O—H). In addition it is possible through hydrolytic cleavage of the urethane bonding to recover amines as well (i.e., in the example above, H₂N—R—NH₂), which after workup can be phosgenated to form isocyanates (in the example above, to form O═C═N—R—N═C═O).

A variety of chemical recycling approaches have been developed in the past. The four most important are briefly summarized as follows:
1. Hydrolysis of urethanes by reaction with water to recover amines and polyols with formation of carbon dioxide.
2. Glycolysis of urethanes by reaction with alcohols, where the polyols incorporated in the urethane groups are released by being replaced with the alcohol used. This process is commonly referred to in the literature as transesterification (more accurately: transurethanization). Regardless of the exact nature of the alcohol used, this mode of chemical recycling is dubbed glycolysis in the literature, a term that really applies only for glycol. In the present invention, therefore, the term used generally is alcoholysis. A glycolysis may be followed by a hydrolysis. If the hydrolysis is conducted in the presence of the as yet unchanged glycolysis mixture, this is called a
3. Hydroglycolysis of urethane compounds by reaction with alcohols and water. It is of course likewise possible to add alcohol and water from the start, in which case the above-described processes of glycolysis and hydrolysis proceed in parallel.
4. Acidolysis of urethane compounds by reaction with carboxylic acids to form acylurea compounds.

A summary of the known methods of polyurethane recycling is offered by the review article by Simón, Borreguero, Lucas and Rodríguez in Waste Management 2018, 76, 147-171 [1].

CN 106 279 760 describes the chemolysis of a polyurethane, comprising mechanical comminution and reaction with water and an alcohol in an inert gas atmosphere in the presence of antioxidants at 218° C. to 399° C. and a pressure of 50 to 150 kPa for 3 to 5 hours, using a carbodiimide as catalyst.

DE 32 32 461 A1 describes a method of continuous glycolytic cleavage of polyurethane polymer wastes, especially polyurethane foam wastes, in multiscrew machines by addition of optionally preheated diols, at cleavage temperatures of >250° C., while maintaining at least such a pressure that the polyurethane-diol mixture is in the liquid phase, discharging the glycolyzate mixture after brief residence times of 2 to 30 minutes in the reaction screw, and rapidly cooling the glycolyzate mixture. In a preferred embodiment, air introduced into the screw machine together with the polymer wastes can escape through a hole in the housing upstream of the introduction funnel counter to the direction of conveying, at which there is advantageously a slightly reduced pressure. The application does not disclose that volatile accompanying substances present in the cell structure of the polyurethane foam, such as oxygen, blowing agents and/or disinfectants in particular, are removed via the hole in the housing. Nor is this to be expected with the arrangement described; instead, it is to be expected that it will indeed only be the air that gets into the machine together with the foam wastes in the course of introduction thereof (the air surrounding the foam wastes) that is removed.

DE 24 42 387 A1 describes a method of continuous hydrolytic cleavage of polymer wastes, in which wastes of hydrolyzable polymer material are introduced into a screw machine together with water and optionally hydrolysis catalysts, where the mixture of water and polymer wastes is subjected to a temperature of 100 to 300° C. at a pressure of 5 to 100 bar for 2 to 100 minutes in a reaction zone with intense transfer of mass and heat, and the liquid-gas mixture formed in the hydrolysis is conveyed continuously into a mouthpiece fixedly connected to the screw machine, from which the gas escapes via a control valve that maintains the constant screw machine pressure in the mouthpiece, and the liquid via a control valve that maintains a constant liquid level within the mouthpiece. In a preferred embodiment, the air introduced together with the polymer wastes is removed via a hole in the housing which is placed upstream of the introduction funnel for the polymer material in conveying direction, at which a slight vacuum is applied. The application does not disclose that volatile accompanying substances present in the cell structure of the polyurethane foam, such as oxygen, blowing agents and/or disinfectants in particular, are removed via the hole in the housing. Nor is this to be expected with a merely gentle vacuum and compression of the foam essentially only after addition of the chemolysis reagent (water here); instead, it is to be assumed that here—just as in the case of DE 32 32 461 A1—it will indeed only be the air that gets into this machine together with the polymer wastes in the course of introduction thereof (the air surrounding the polymer wastes) that is removed.

DE 197 19 084 A1 discloses a method of producing polyols from polyurethane wastes, in which foam flakes, ground flexible foam or shredded material is introduced into a reactor containing wastes from the synthesis of polyesters that have been heated beforehand to a temperature above 70° C. The mixture of the polyurethane wastes and the wastes from the polyester synthesis is heated further and converted by a controlled catalytic transesterification reaction at a temperature of 120° C. to 250° C. In a preferred embodiment, the polyurethane wastes are introduced by means of pneumatic conveying by a gentle nitrogen stream. Removal of volatile accompanying substances present in the cell structure of the polyurethane foam, such as oxygen, blowing agents and/or disinfectants in particular, is not to be expected in this way.

DE 10 2004 014165 A1 describes a method of producing polyols from polyurethane wastes, and a specific apparatus for performing said method. In this case, the precomminuted flexible foam is metered in from above via a stuffing screw and a constriction ring, with removal, according to this document, of the gases present in the foam. However, it is doubtful whether oxygen present in the cell structure of the polyurethane foam can indeed be at least essentially completely removed without application of reduced pressure before commencement of the chemolysis. This is all the more true of accompanying substances that potentially impair recycling and are possibly present in the cell structure of the polyurethane foam, since these boil at a significantly higher level than oxygen, such as blowing agents or disinfectants (which may also be in liquid form).

EP 0 031 538 A2 describes a method and apparatus for processing of polyurethane obtained from wastes by alcoholysis or acidolysis. This involves first mechanically comminuting the polyurethane to give a starting material and then treating it with solvents at a temperature of more than 120° C. At least at the start of solvent treatment, which leads to the liquefaction of the starting material and is conducted at a reaction temperature of below 200° C., there is a continuation of the mechanical comminution of the starting material which is already being chemically degraded. This method, according to the statements in this document, results in a shorter duration of treatment at a lower temperature before complete dissolution of the starting material, without occurrence of quality-impairing discolouration or leaving undissolved residues. The starting material is of course dissolved with at least partial reaction of the polyurethane bonds.

The plant for performance of the method has a mixer charged from reservoir vessels, connected on the exit side to a reactor in which shear elements that exert shear forces and can be set in rotation in both directions act on the starting material, these being disposed on a hollow, heatable shaft and being surrounded by a reactor shell composed of hollow, heatable sectors. This reactor improves the heat transfer to the mass, such that a homogeneous temperature distribution and hence a comparatively short reaction time and dissolution time is achievable. The application discloses an embodiment in which the starting material is precomminuted while mixing with a proportion of the polyols used later as a solvent constituent in a heatable kneading mixer with two co-rotating shafts having sigma blades. According to this document, this achieves good preliminary wetting of the polyurethane particle surfaces with solvent, releases a portion of the gases trapped in the polyurethane cell region, reduces the damaging oxygen content, and especially avoids the agglomeration of the polyurethane particles as a result of the subsequent mechanical stresses in the downstream reaction zone and crucially increases the meterability and thermal conductivity of the mass of the starting material. The substantial removal of the atmospheric oxygen, according to this application, can be brought about by subsequent evacuation of the mixture in the same part of the plant and/or by subsequent purging the protective gas, for example nitrogen, at standard pressure. However, it should be noted here that the presence of a solvent that wets the polyurethane (=chemolysis reagent) counteracts effective degassing.

As well as the processes of physical recycling (mechanical comminution of the polyurethane products and addition in the production of new polyurethane products) and chemical recycling (recovery of polyols and preferably also amines by chemical cleavage of the urethane bonds) that have been mentioned, mention should also be made of “upcycling”, which assumes an intermediate position: In the case of upcycling, as in the case of chemical recycling, a chemical change in the polyurethane takes place, but this does not proceed as far as recovery of the raw materials originally used in the synthesis (polyol and amine), but has the aim of converting the polyurethane to be reutilized to a different polymeric product of value. For instance, D. T. Sheppard et al. in the article Reprocessing Postconsumer Polyurethane Foam Using Carbamate Exchange Catalysis and Twin-Screw Extrusion (ACS Cent. Sci. 2020 6 (6), 921-927) describe the treatment of a crosslinked polyurethane foam with dibutyltin dilaurate in dichloromethane, followed by mechanical processing of the foam thus treated in a twin-screw mixer or twin-screw extruder, with removal of air, to obtain films or fibers.

Only few of the literature processes for recycling of polyurethanes are being implemented in a sustained manner on an industrial scale; many have not even reached pilot scale [1]. In view of generally increased environmental awareness and increased efforts to configure industrial processes to be as sustainable as possible, this shows clearly that the recycling of polyurethane products is still by no means mature from a technical and economic point of view. The opportunities for physical recycling are obviously very limited Upcycling can open up routes to viable reutilization of polyurethane products, and in this respect has validity, but does not enable closure of the raw material cycles. The potential to do so is offered only by chemical recycling, if it is possible to recover the polyols used and preferably also the amines, such that these can be used in the production of new polyurethane products of comparable quality to original polyurethane products. In this regard, challenges exist particularly with regard to the purity of the products recovered. Polyols must be recovered without amine impurities if at all possible, in order, for instance, not to adversely affect foaming characteristics in the case of reuse in the production of polyurethane foams. If another aim is recovery of amines, these must of course also be obtained in maximum purity. Moreover, an economic recycling process must ensure that the reagents used (for example alcohols used) can be recovered and reused (i.e. recirculated) as completely as possible.

The polyurethane products to be reutilized usually still contain various auxiliaries and additives (stabilizers, catalysts and the like), which have to be separated from the actual target products of the recycling and disposed of in an economically viable and environmentally benign manner. In the case of polyurethane foams, particular mention should also be made of blowing agents and oxygen, both of which are present in the cell structure of the foams. As well as these auxiliaries and additives that are present for production-related reasons, preparatory steps that precede the actual chemical recycling can cause further extraneous substances to get into a polyurethane product to be recycled. For example, it is customary to treat polyurethane foams to be reused, which come from old mattresses or seating furniture, for instance, with disinfectants. These extraneous substances can impair chemical recycling and/or the subsequent use of the raw materials recovered in new production processes:

Oxygen can cause oxidation reactions of the amine in particular. Even from a safety point of view, the presence of oxygen is problematic, given that the operating temperature is offered above the flashpoint of the alcohol used in alcoholyses for instance. Blowing agents used, such as pentane, are chemically inert, but accumulate as well for that specific reason and regularly have to be discharged with loss of product (purge). The presence of blowing agents can also aggravate the offgas burden and make it difficult to work up the offgas. Certain commonly used disinfectants, for example ethanol, can form carbamates in the chemolysis, some of which are more difficult to cleave to release the amine than the carbamates of the actual chemolysis reagent (usually glycol or a glycol derivative). Even if the carbamate cleavage succeeds, such alcoholic disinfectants get into the unconverted chemolysis reagent as an impurity in the workup, which can complicate the recovery thereof. Other commonly used disinfectants, such as hydrogen peroxide or sodium hypochlorite, can break down to release oxygen. The prior art still does not offer a satisfactory solution for such problems.

There is therefore a need for further improvements in the field of chemical recycling of polyurethane foams. In particular, it would be desirable to remove potentially troublesome accompanying substances, such as blowing agents, oxygen or disinfectants, as far as possible from the polyurethane foam actually before commencement of the actual chemical recycling to such an extent that they do not disrupt the subsequent steps.

Taking account of the requirements outlined, the present invention therefore provides a method of recovering raw materials (i.e. of polyols and optionally amines) from a polyurethane foam which is based on an isocyanate component and a polyol component and has a cell structure comprising a component X selected from the group consisting of oxygen, a blowing agent, a disinfectant and a mixture of two or more of the above, wherein component X comprises at least oxygen, by reacting the polyurethane foam with a chemolysis reagent, said method comprising:
(A) providing the polyurethane foam (1) in a vessel (100);
(B) chemolyzing the polyurethane foam (1)
   in a chemolysis apparatus comprising (i) an inlet device (200), (ii) a chemolysis reactor (300) connected to the inlet device, (iii) an outlet device (400) connected to the chemolysis reactor, and (iv) a gas removal device (500) disposed in the vessel and/or in the inlet device,
   wherein the chemolysis comprises:
   (B.I) introducing the polyurethane foam from the vessel into the inlet device and thence into the chemolysis reactor, where the polyurethane foam is degassed before being contacted with the chemolysis reagent by
      (α) removing at least oxygen (i.e. (i) the oxygen present in component X and (ii) any oxygen formed by decomposition reactions of constituents of component X), but preferably all constituents of component X or any gaseous decomposition products thereof, from the chemolysis apparatus at a pressure of not more than 960 mbar_{(abs.)} and a temperature of not more than 120° C. in gaseous form via the gas removal device,
      so as to obtain a degassed polyurethane foam (2);
   (B.II) reacting the degassed polyurethane foam (2) in the chemolysis reactor (300) with a chemolysis reagent (4) in the presence of a catalyst in an inert gas atmosphere to obtain a product mixture;
   (B.III) discharging the product mixture from the chemolysis reactor (300) through the outlet device (400); followed by
working up the product mixture, comprising:
(C) recovering (at least) a polyol (from the polyol component or a degradation product thereof which is obtained in the chemolysis); and
(D) optionally, recovering (at least) an amine corresponding to an isocyanate from the isocyanate component.

It has been found that, surprisingly, the removal according to the invention of volatile accompanying substances as defined in component X before the first contact of the polyurethane foam with the chemolysis reagent leads to particularly careful depletion of such accompanying substances, and hence overcomes or at least minimizes the problems outlined above. Oxygen in particular, whether present from the outset or formed in situ, for example, as a result of the decomposition of a disinfectant, such as hydrogen peroxide or sodium hypochlorite, is successfully removed by the method according to the invention, which avoids oxidation reactions, especially of the amine. This is because it is a feature of the method according to the invention that accompanying substances present not just superficially or in adhering form, but also volatile accompanying substances present in the cell structure of the polyurethane foam, can be removed successfully.

This is because, as known to the person skilled in the art, a polyurethane foam has a cell structure (also called pore structure) which can be influenced by chemical or chemical engineering parameters in the foaming operation. In the production of polyurethane foams, blowing agents are used, which are in gaseous form under the production conditions of foaming and lead to the formation of foam cells (also called foam pores) that are connected to one another via lamellas. Polyurethanes for reutilization include accompanying substances that are regularly volatile and potentially disrupt chemolysis, which may be present in the cells (i.e. in the cavities), but also in the lamellas (for example when the lamellas are filled with a disinfectant).

The present invention is thus concerned with freeing the polyurethane foams from such volatile accompanying substances before commencement of chemical recycling, i.e. before the first contact of a polyurethane foam to be reutilized with chemolysis reagent. A volatile accompanying substance in this context, i.e. a component X, is understood in the context of the present invention to mean oxygen, a blowing agent, a disinfectant or a mixture of two or more of the above, especially if the volatile accompanying substance (i.e. component X or a constituent thereof) is in gaseous form or decomposes to form gaseous decomposition products at least in a subregion of a pressure and temperature range defined by a lower pressure limit p_{U}, an upper pressure limit p_{O}, a lower temperature limit T_{U} and an upper temperature limit T_{O}, where:
p_{U}=0.1 mbar_{(abs.)};
p_{O}=960 mbar_{(abs.)};
T_{U}=−20° C., especially (namely if the volatile accompanying substances present in the cell structure are liquid under standard conditions [i.e. at a temperature of 0° C. and a pressure of 1.000 bar_{(abs.)}]) 16° C.,
and
T_{O}=120° C.

The pressures p_{U} and p_{O} may be determined by means of a conventional manometer. This is of course likewise true of the pressures p1 and p2, which are described further down. It will be appreciated that the presence of further compounds that could be described as “volatile accompanying substances” in purely linguistic terms but are not covered by the definition of component X in the context of the present invention is not ruled out, and recycling of such polyurethane foams by the method according to the invention does not leave the scope of the invention.

The condition mentioned is satisfied for oxygen; this is regularly likewise true of blowing agents (e.g. pentane) that are employed in the polyurethane foam production. The great majority of conventional disinfectants can also be converted to the gas phase or to gaseous decomposition products under the conditions mentioned, and so troublesome substances can be discharged via the gas removal device. Examples of decomposable volatile accompanying substances are hydrogen peroxide and sodium hypochlorite, both of which have a tendency to decompose to form oxygen inter alia, which can then be removed as a “gaseous decomposition product” via the gas removal device.

In the terminology of the present invention, the term isocyanates encompasses all isocyanates known to the person skilled in the art in association with polyurethane chemistry, such as, in particular, tolylene diisocyanate (TDI; preparable and preferably prepared from tolylenediamine, TDA), the di- and polyisocyanates of the diphenylmethane series (MDI; preparable and preferably prepared from the di- and polyamines of the diphenylmethane series, MDA), pentane 1,5-diisocyanate (PDI; preparable and preferably prepared from pentane-1,5-diamine, PDA), hexamethylene 1,6-diisocyanate (HDI; preparable and preferably prepared from hexamethylene-1,6-diamine, HDA), isophorone diisocyanate (IPDI; preparable and preferably prepared from isophoronediamine, IPDA) and xylylene diisocyanate (XDI; preparable and preferably prepared from xylylenediamine, XDA). The expression “an isocyanate” of course also encompasses embodiments in which two or more different isocyanates (e.g. mixtures of MDI and TDI) were used in the preparation of the polyurethane product, unless explicitly stated otherwise, for instance by the formulation “exactly one isocyanate”. The entirety of all isocyanates used in the preparation of the polyurethane product is referred to as isocyanate component (of the polyurethane product). The isocyanate component comprises at least one isocyanate. Analogously, the entirety of all polyols used in the preparation of the polyurethane product is referred to as polyol component (of the polyurethane product). The polyol component comprises at least one polyol.

In the terminology of the present invention, the term polyols encompasses all polyols known to the person skilled in the art in association with polyurethane chemistry, such as, in particular, polyether polyols, polyester polyols, polyetherester polyols and polyethercarbonate polyols. The expression “a polyol” does of course also encompass embodiments in which two or more different polyols were used in the production of the polyurethane product. If, therefore, reference is made, for example, to “a polyether polyol” (or “a polyester polyol” etc.), this terminology does of course also encompass embodiments in which two or more different polyether polyols (or two or more different polyester polyols etc.) were used in the preparation of the polyurethane product.

Carbamates in the terminology of the present invention referred to the urethanes formed in step (B) by the reaction with the alcohol.

An amine corresponding to an isocyanate refers to that amine that can be phosgenated to give the isocyanate: R—NH₂+COCl₂→R—N═C═O+2HCl. Analogously, a nitro compound corresponding to an amine is that nitro compound that can be reduced to give the amine: R—NO₂+3H₂→R—NH₂+2H₂O.

All pressure figures relate to absolute pressures, indicated by a suffix “abs.” to the unit of pressure (e.g. “mbar_{(abs.)}”).

The invention is accordingly concerned with the recycling of those polyurethane foams wherein the cell structure contains oxygen, (at least) a blowing agent, and/or (at least) a (volatile) disinfectant (or one decomposable to form volatile products), i.e. one, more than one or all of the volatile accompanying substances mentioned, although oxygen is always present. In the terminology of the present invention, the expression “component X” is used as a umbrella term for all volatile accompanying substances present in this context.

The method according to the invention at least essentially completely removes at least the oxygen present (from any origin). Preferably, all constituents of component X or gaseous decomposition products thereof are at least essentially fully removed. In this regard, the invention provides two alternative solutions, as elucidated in detail hereinafter. What is common to all is that, in (B)(I)(α), oxygen, preferably all constituents of component X or gaseous decomposition products thereof “are removed in gaseous form [ . . . ] at a pressure of not more than 960 mbar_{(abs.)} and a temperature of not more than 120° C.”. This means that at least the oxygen present, but preferably also the blowing agent and the disinfectant as well, if they are present (it is not obligatory that all the volatile accompanying substances mentioned are present; for example, a disinfection of the polyurethane foam is not required in all cases), are removed at least essentially completely from the polyurethane foam before the actual chemolysis reaction commences.

It is a particular feature of the first alternative solution that the removal of the volatile accompanying substances is brought about essentially by a significant pressure reduction, followed by a pressure increase. For this purpose, the polyurethane foam, for performance of the degassing in (B.I),
(1) is subjected in a first step at a first temperature (T1) in the range from −20° C. to 120° C. to a first pressure (p1) in the range from 0.1 mbar_{(abs.)} to 100 mbar_{(abs.)} (where the first pressure in particular is matched to the first temperature such that all constituents of component X to be removed in (B)(I)(α) that are not in gaseous form in any case, like oxygen, are converted to the gas phase or decompose to form gaseous products),
   and
(2) is subjected in a second step, by supplying an inert gas, to a second pressure (p2) which is greater than the first pressure and is not more than 2.0 bar_{(abs.)}.

A “degassed polyurethane foam (2)” in this context thus refers to a polyurethane foam that has been freed of volatile accompanying substances of the type specified and saturated with an inert gas.

It is a particular feature of the second alternative solution that the removal of the volatile accompanying substances is brought about essentially by mechanical compression of the polyurethane foam (the volatile accompanying substances are pushed out of the cell structure of the polyurethane foam and pulled into a region of reduced pressure). For this purpose, the polyurethane foam, for performance of the degassing in (B.I),
(1) is conveyed in a first step at a first temperature (T1) in the range from −20° C. to 120° C. and a first pressure (p1) in the range from 0.1 mbar_{(abs.)} to 960 mbar_{(abs.)}, especially 100 mbar_{(abs.)} to 960 mbar_{(abs.)}, to a device for mechanical compression which is disposed within the inlet device (where the first pressure in particular is matched to the first temperature such that all constituents of component X to be removed in (B)(I)(α) that are not in gaseous form in any case, like oxygen, are converted to the gas phase or decompose to form gaseous products), wherein the gas removal device is upstream of the device for mechanical compression,
   and
(2) is compressed in a second step in the device for mechanical compression at a second pressure (p2) in the range from 5 bar_{(abs.)} to 200 bar_{(abs.)} (this pushes the volatile constituents out of the cell structure and pulls them into the region of the inlet device upstream of the device for mechanical compression, where they are then removed via the gas removal device).

A “degassed polyurethane foam (2)” in this context thus refers to a polyurethane foam that has been freed of volatile accompanying substances of the type specified and compressed (and is sent in compressed form to the chemolysis conducted in an inert gas atmosphere).

The appended drawings show specific ways of implementing these two alternative solutions:

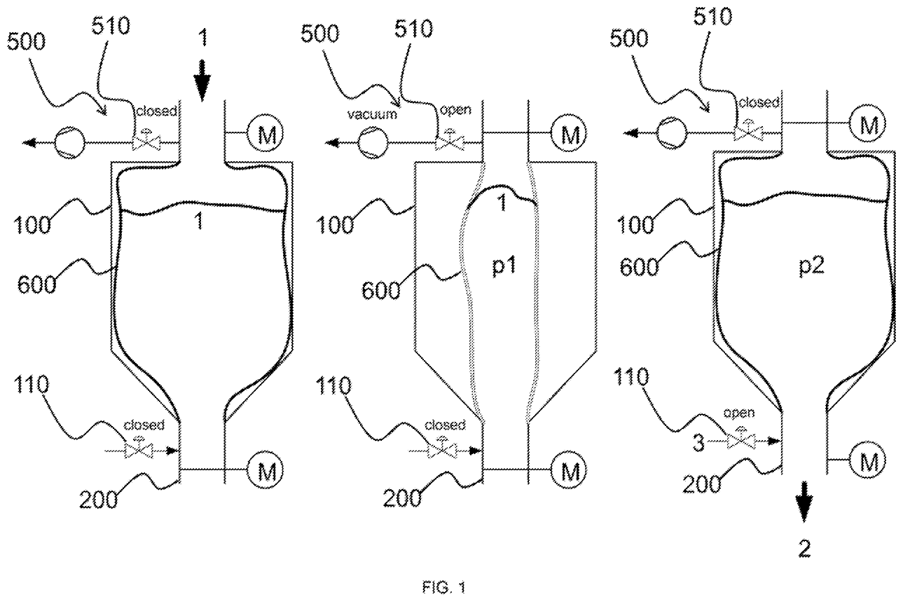

FIG. 1 shows a first variant of the method according to the invention using a flexible lining made of polyethylene, for example (first alternative solution),

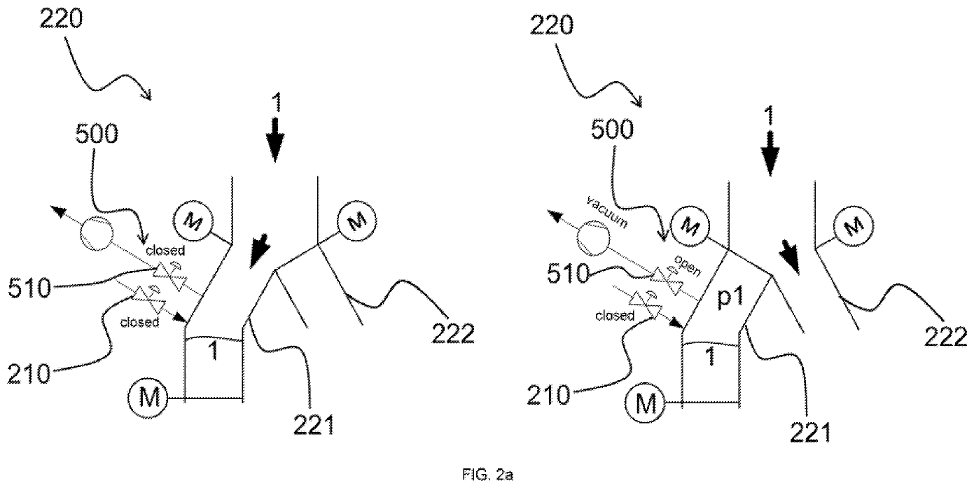

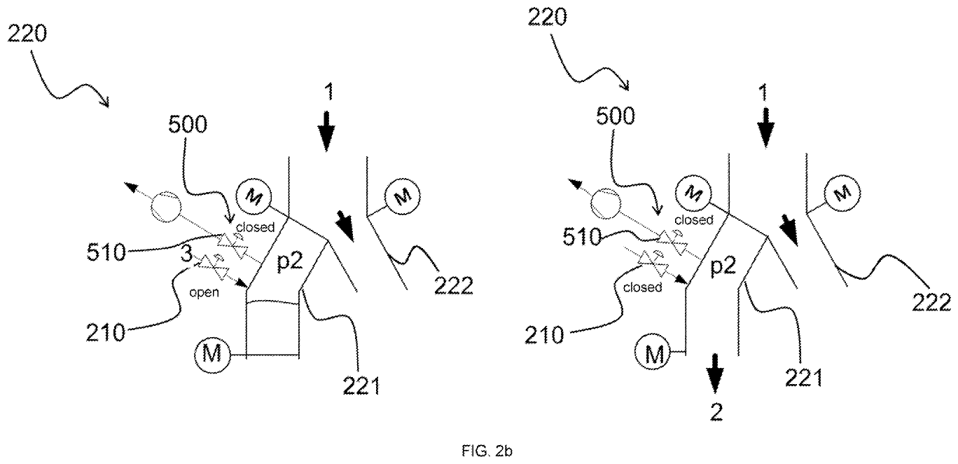

FIG. 2a,b show a second variant of the method according to the invention using a lock system (first alternative solution),

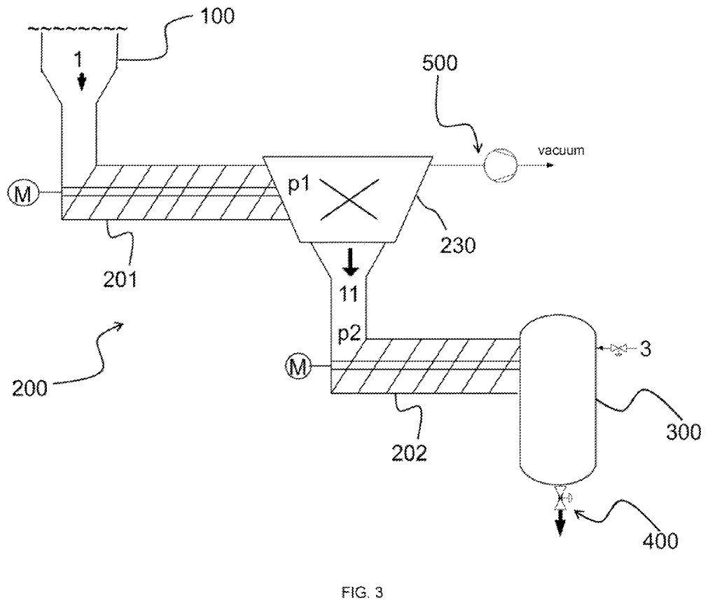

FIG. 3 shows a third variant of the method according to the invention using a device for mechanical comminution (first alternative solution) and

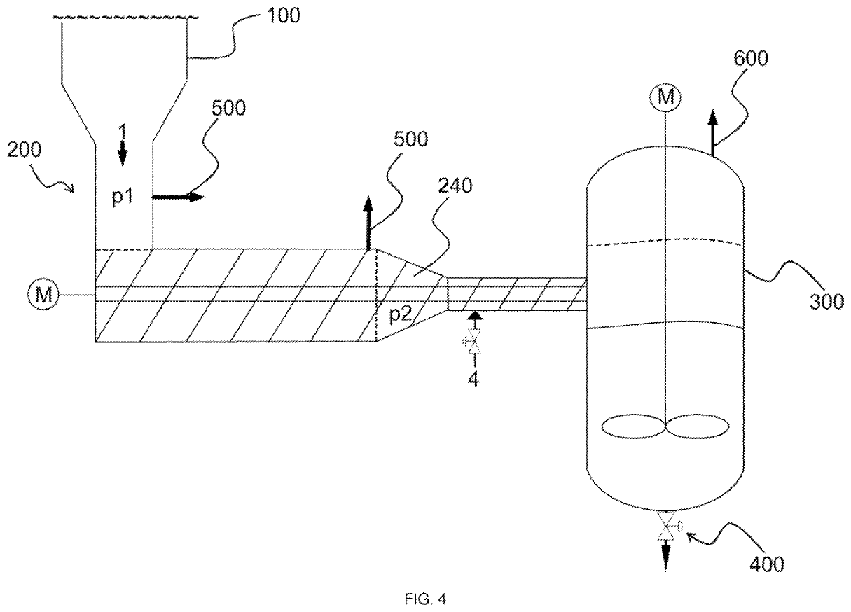

FIG. 4 shows a fourth variant of the method according to the invention using a device for mechanical compression (second alternative solution).

There now follows a brief summary of various possible embodiments of the invention.

In a first embodiment of the invention, which corresponds to a first variant and forms part of the first alternative solution, the vessel and/or the inlet device has been provided with an internal flexible lining which is collapsed in the first step by establishment of the first pressure and hence compresses the polyurethane foam, and is expanded again in the second step by supply of an inert gas to established the second pressure.

In a second embodiment of the invention, which is a particular configuration of the first embodiment and can be combined with all other embodiments of the first variant, the flexible lining is a film of polyethylene, polypropylene, aluminum, polyvinylchloride, polyetheretherketone, polystyrene, polycarbonate, polyester, polyethylene terephthalate, or a composite of the aforementioned materials.

In a third embodiment of the invention, which is a particular configuration of the first embodiment and can be combined with all other embodiments of the first variant, the first and second steps are repeated, especially twice to 5 times.

In a fourth embodiment of the invention, which is a particular configuration of the first embodiment and can be combined with all other embodiments of the first variant, the second pressure is not more than 1.8 bar_{(abs.)} and is especially equal to the ambient pressure.

In a fifth embodiment of the invention, which is a particular configuration of the first embodiment and can be combined with all other embodiments of the first variant, the first temperature is in the range from 0° C. to 80° C., preferably from 16° C. to 80° C.

In a sixth embodiment of the invention, which is a particular configuration of the first embodiment and can be combined with all other embodiments of the first variant, the second step is conducted at a second temperature (T2) which is within a range from −20° C. to 120° C., preferably 0° C. to 80° C., more preferably 16° C. to 80° C., and especially corresponds to the first temperature (i.e. no specific change in temperature is implemented at the transition from the first to the second step).

In a seventh embodiment of the invention, which corresponds to a second variant and likewise forms part of the first alternative solution, the inlet device has a first lock region (upstream of the chemolysis reactor), having a closable feed device for the polyurethane foam provided in step (A) and a closable removal device for the degassed polyurethane foam,

wherein step (B.I) includes the following steps:
(B.I.1.a) closing the removal device of the first lock region, introducing polyurethane foam into the first lock region and closing the feed device of the first lock region;
(B.I.2.a) performing the first step of (B.I) in the first lock region;
(B.I.3.a) performing the second step of (B.I) in the first lock region by supplying the inert gas to obtain degassed polyurethane foam;
(B.I.4.a) transferring the degassed polyurethane foam obtained in (B.I.3.a) into the chemolysis reactor.

In an eighth embodiment of the invention, which is a particular configuration of the seventh embodiment and can be combined with all other embodiments of the second variant, the inlet device, in addition to the first lock region, has a second lock region having a closable feed device for the polyurethane foam provided in step (A) and a closable removal device for the degassed polyurethane foam,

wherein a first portion of the polyurethane foam is introduced into the first lock region in step (B.I.1.a), such that a first portion of the degassed polyurethane foam is obtained in step (B.I.3a), wherein step (B.I) additionally includes the following steps:
(B.I.1.b) closing the removal device of the second lock region, introducing a second portion of the polyurethane foam into the second lock region and closing the feed device of the second lock region;
(B.I.2.b) performing the first step of (B.I) in the second lock region;
(B.I.3.b) performing the second step of (B.I) in the second lock region by supplying the inert gas to obtain a second portion of the degassed polyurethane foam;
(B.I.4.b) transferring the second portion of the degassed polyurethane foam into the chemolysis reactor;
   wherein steps (B.I.1.a) to (B.I.4.a) are matched to steps (B.I.1.b) to (B.I.4.b) such that degassed polyurethane foam is transferred continuously into the chemolysis reactor.

In a ninth embodiment of the invention, which is a particular configuration of the seventh embodiment and can be combined with all other embodiments of the second variant, the first temperature is in the range from 0° C. to 80° C., preferably 16° C. to 80° C.

In a tenth embodiment of the invention, which is a particular configuration of the seventh embodiment and can be combined with all other embodiments of the second variant, the polyurethane foam is first contacted with the chemolysis reagent in the chemolysis reactor.

In an eleventh embodiment of the invention, which is a particular configuration of the seventh embodiment and can be combined with all other embodiments of the second variant, the second step is conducted at a second temperature (T2) which is within a range from −20° C. to 120° C., preferably 0° C. to 80° C., more preferably 16° C. to 80° C., and especially corresponds to the first temperature (i.e. no specific change in temperature is implemented at the transition from the first to the second step).

In a twelfth embodiment of the invention, which is a particular configuration of the seventh embodiment and can be combined with all other embodiments of the second variant, provided that these are not restricted to the addition of the chemolysis reagent only in the chemolysis reactor, the polyurethane foam is still contacted, especially wetted, with chemolysis reagent (and optionally already with the catalyst) in the first and/or second lock region after the second step.

In a thirteenth embodiment of the invention, which is a particular configuration of the twelfth embodiment, the chemolysis reagent on contacting with the polyurethane foam in the first and/or second lock region is at a temperature in the range from 120° C. to 240° C., especially >120° C. to 240° C.

In a fourteenth embodiment of the invention, which is a particular configuration of the seventh embodiment and can be combined with all other embodiments of the second variant, the second pressure is not more than 1.8 bar_{(abs.)} and is especially equal to ambient pressure.

In a fifteenth embodiment of the invention, which corresponds to a third variant and likewise forms part of the first alternative solution, the polyurethane foam is conveyed during the first step of (B.I) through a device for mechanical comminution which is disposed in a first portion of the inlet device and is comminuted, wherein the second step is conducted in such a way that the polyurethane foam after the mechanical comminution is conveyed through a second part, downstream of the first part, of the inlet device into an inert gas atmosphere under the second pressure.

In a sixteenth embodiment of the invention, which is a particular configuration of the fifteenth embodiment and can be combined with all other embodiments of the third variant, the conveying of the polyurethane foam in the first and second part of the inlet device is undertaken by means of
(at least) a screw shaft,
(at least) a piston,
(at least) a conveyor belt,
vibration and/or
gravity.

In an eighteenth embodiment of the invention, which is a particular configuration of the fifteenth embodiment and can be combined with all other embodiments of the third variant, the device for mechanical comminution comprises a cutting mill, a knife mill, an impact cup and/or a hammer mill.

In a nineteenth embodiment of the invention, which is a particular configuration of the eighteenth embodiment, the device for mechanical comminution comprises an impact cup and/or a hammer mill, where the first temperature is in the range from <0° C. to −20° C.

In a twentieth embodiment of the invention, which is a particular configuration of the fifteenth embodiment and can be combined with all other embodiments of the third variant except for the nineteenth, the first temperature is in the range from 0° C. to 80° C., preferably 16° C. to 80° C.

In a twenty-first embodiment of the invention, which is a particular configuration of the fifteenth embodiment and can be combined with all other embodiments of the third variant, the polyurethane foam is first contacted with chemolysis reagent in the chemolysis reactor.

In a twenty-second embodiment of the invention, which is a particular configuration of the fifteenth embodiment and can be combined with all other embodiments of the third variant, the second step is conducted at a second temperature (T2) which is within a range from −20° C. to 120° C., preferably 0° C. to 80° C., more preferably 16° C. to 80° C., and especially corresponds to the first temperature (i.e. no specific change in temperature is implemented at the transition from the first to the second step).

In a twenty-third embodiment of the invention, which is a particular configuration of the fifteenth embodiment and can be combined with all other embodiments of the third variant, provided that these are not restricted to the addition of the chemolysis reagent only in the chemolysis reactor, the polyurethane foam is still contacted, especially wetted, with chemolysis reagent (and optionally already with the catalyst) in the second portion of the inlet device after the second step.

In a twenty-fourth embodiment of the invention, which is a particular configuration of the twenty-third embodiment, the chemolysis reagent on contacting with the polyurethane foam in the second portion of the inlet device is at a temperature in the range from 120° C. to 240° C., especially >120° C. to 240° C.

In a twenty-fifth embodiment of the invention, which is a particular configuration of the fifteenth embodiment and can be combined with all other embodiments of the third variant, the second pressure is not more than 1.8 bar_{(abs.)} and is especially equal to ambient pressure.

In a twenty-sixth embodiment of the invention, which corresponds to a fourth variant and is a particular configuration of the second alternative solution and can be combined with all other embodiments of the fourth variant, the gas removal device is disposed within the inlet device.

In an twenty-seventh embodiment of the invention, which is a particular configuration of the twenty-sixth embodiment and can be combined with all other embodiments of the fourth variant, the device for mechanical compression comprises an extruder (also including multizone screws, and single- and multi-shaft extruders), a roller or a piston.

In a twenty-eighth embodiment of the invention, which is a particular configuration of the twenty-sixth embodiment and can be combined with all other embodiments of the fourth variant, the polyurethane foam, after passing through the device for mechanical compression (i.e. after the second step), is still contacted, especially wetted, with the chemolysis reagent in the inlet device.

In a twenty-ninth embodiment of the invention, which is a particular configuration of the twenty-eighth embodiment, the chemolysis reagent on contacting with the polyurethane foam in the inlet device is at a temperature in the range from 120° C. to 240° C.

In a thirtieth embodiment of the invention, which is a particular configuration of the twenty-sixth embodiment and can be combined with all other embodiments of the fourth variant, the first temperature is in the range from 0° C. to 80° C., preferably 16° C. to 80° C.

In a thirty-first embodiment of the invention, which is a particular configuration of the twenty-sixth embodiment and can be combined with all other embodiments of the fourth variant, the second step is conducted at a second temperature (T2) which is within a range from −20° C. to 120° C., preferably 0° C. to 80° C., more preferably 16° C. to 80° C., and especially corresponds to the first temperature (i.e. no specific change in temperature is implemented at the transition from the first to the second step).

In a thirty-second embodiment of the invention, which can be combined with embodiments of all four variants, step (B.II) is conducted at a temperature range from 140° C. to 240° C., preferably 160° C. to 240° C., more preferably 180° C. to 220° C.

In a thirty-third embodiment of the invention, which can be combined with embodiments of all four variants, step (B.II) is conducted at a pressure in the range from >960 mbar_{(abs.)} to 1.8 bar_{(abs.)}, especially at ambient pressure.

In a thirty-fourth embodiment of the invention, which can be combined with all embodiments of all four variants, component X contains at least one constituent which is liquid under standard conditions (i.e. at a temperature of 0° C. and a pressure of 1.000 bar_{(abs.)}), where the first temperature is at least 16° C.

In a thirty-fifth embodiment of the invention, which can be combined with all embodiments of all four variants,
the blowing agent comprises (especially is) pentane, a hydrochlorofluorocarbon, dichloromethane or a mixture of two or more of the aforementioned blowing agents; and
the disinfectant comprises (especially is) hydrogen peroxide, chlorine dioxide, formaldehyde, peracetic acid, an alkali metal hypochlorite (especially sodium hypochlorite), ethanol, isopropanol, 1-propanol, or a mixture of two or more of the aforementioned disinfectants.

In a thirty-sixth embodiment of the invention, which can be combined with all embodiments of all four variants, the isocyanate component contains an isocyanate selected from tolylene diisocyanate (TDI), the di- and polyisocyanates of the diphenylmethane series (MDI), pentane 1,5-diisocyanate (PDI), hexamethylene 1,6-diisocyanate (HDI), isophorone diisocyanate (IPDI), xylylene diisocyanate (XDI) or a mixture of two or more of the aforementioned isocyanates. Particular preference is given to polyurethane foams that are based, with regard to the isocyanate component, on a mixture of TDI and MDI. Very particular preference is given to polyurethane products that are based solely on TDI with regard to the isocyanate component.

In a thirty-seventh embodiment of the invention, which can be combined with all embodiments of all four variants, the polyol component contains a polyol selected from a polyether polyol, a polyester polyol, a polyetherester polyol, a polyethercarbonate polyol or a mixture of two or more of the aforementioned polyols. The polyol component is preferably a polyether polyol. More preferably, the polyol component is a polyether polyol (i.e. does not contain any polyols other than polyether polyols; but a mixture of two or more different polyether polyols is encompassed and does not leave the scope of this embodiment).

In a thirty-eighth embodiment of the invention, which can be combined with all embodiments of all four variants, the isocyanate component contains tolylene diisocyanate (TDI) and di- and polyisocyanates of the diphenylmethane series (MDI) (especially TDI only), and the polyol component contains a polyether polyol (and in particular is a polyether polyol, i.e. does not contain any further polyols other than polyether polyols, although a mixture of two or more different polyether polyols is included and does not depart from the scope of this embodiment).

In a thirty-ninth embodiment of the invention, which can be combined with all embodiments of all four variants, the chemolysis reagent comprises an alcohol selected from ethylene glycol, diethylene glycol, propylene glycol, dipropylene glycol, methyl glycol, triethylene glycol, glycerol, 2-methylpropane-1,3-diol or a mixture of two or more of the aforementioned alcohols.

In a fortieth embodiment of the invention, which is a particular configuration of the forty-second embodiment, the chemolysis reagent comprises water.

In a forty-first embodiment of the invention, which can be combined with all embodiments of all four variants, the catalyst is selected from an alkali metal hydroxide, an alkaline earth metal hydroxide, an alkali metal salt of a carboxylic acid (especially an acetate), an alkaline earth metal salt of a carboxylic acid (especially an acetate), a Lewis acid (especially dibutyltin dilaurate, tin octoate, monobutyltin oxide or tetrabutyl titanate) and/or an organic amine (especially diethanolamine, 1,1,3,3-tetramethylguanidine, 1,8-diazabicyclo(5.4.0)undec-7-ene or 1,4-diazabicyclo[2.2.2]octane).

In a forty-second embodiment of the invention, which can be combined with all embodiments of all four variants, the chemolysis reagent on contacting with the polyurethane foam is at a temperature in the range from 120° C. to 240° C., especially >120° C. to 240° C.

The embodiments briefly outlined above and further possible embodiments of the invention are elucidated in detail hereinafter. All embodiments and other configurations of the invention may be combined with one another as desired unless stated otherwise or unambiguously apparent from the context.

### Provision of the Polyurethane Foam for Chemical Recycling

In step (A) of the method according to the invention, the polyurethane foam to be chemically recycled is provided.

The polyurethane foam may in principle be of any kind; in particular, both flexible foams and rigid foams are useful, preference being given to flexible foams (for example from used mattresses, furniture cushioning or car seats). Such polyurethane foams are produced using a blowing agent. Aside from water-blown foams (in the case of which hydrolysis in situ releases carbon dioxide), pentane in particular is a commonly used blowing agent. In the recycling of used polyurethane foams it is conceivable that the hydrochlorofluorocarbons that were formerly conventionally used as blowing agent were used. A further conceivable blowing agent is dichloromethane.

In addition, preference is given to those polyurethane foams that are based, with regard to the isocyanate component, on an isocyanate selected from tolylene diisocyanate (TDI), the di- and polyisocyanates of the diphenylmethane series (MDI), pentane 1,5-diisocyanate (PDI), hexamethylene 1,6-diisocyanate (HDI), isophorone diisocyanate (IPDI), xylylene diisocyanate (XDI) and mixtures of two or more of the aforementioned isocyanates. Particular preference is given to polyurethane foams that are based, with regard to the isocyanate component, on a mixture of TDI and MDI. Very particular preference is given to polyurethane products that are based solely on TDI with regard to the isocyanate component.

With regard to the polyol component, preference is given to those polyurethane foams that are based on a polyol selected from the group consisting of a polyether polyol, a polyester polyol, a polyetherester polyol, a polyethercarbonate polyol, or a mixture of two or more of the aforementioned polyols. The polyol component is preferably a polyether polyol. More preferably, the polyol component is a polyether polyol (i.e. does not contain any polyols other than polyether polyols; but a mixture of two or more different polyether polyols is encompassed and does not leave the scope of this embodiment).

Most preferably, the polyurethane foam is a foam wherein the isocyanate component contains tolylene diisocyanate (TDI) and di- and polyisocyanates of the diphenylmethane series (MDI), especially TDI only, and wherein the polyol component contains a polyether polyol (and in particular is a polyether polyol, i.e. does not contain any further polyols other than polyether polyols, although a mixture of two or more different polyether polyols is included and does not depart from the scope of this embodiment).

Preferably, already step (A) comprises preparatory steps for the cleavage of the urethane bonds in step (B.II). These are especially mechanical comminution of the polyurethane foams. Such preparatory steps are known to the person skilled in the art; reference is made by way of example to the literature cited in [1]. Depending on the characteristics of the polyurethane foam, it can be advantageous to “freeze” it before the mechanical comminution in order to facilitate the comminuting operation.

Before, during or after the mechanical comminution, there may be a treatment of the polyurethane foam with (aqueous or alcoholic) disinfectants. Such disinfectants are preferably hydrogen peroxide, chlorine dioxide, formaldehyde, alkali metal hypochlorites (especially sodium hypochlorite) and/or peracetic acid (aqueous disinfectants), or ethanol, isopropanol and/or 1-propanol (alcoholic disinfectants). Especially in the case of performance of such a disinfecting treatment, the compounds present in the cell structure also include those that are liquid under standard conditions, i.e. at a temperature of 0° C. and a pressure of 1.000 bar_{(abs.)}. In this case, it is preferable to choose a value of 16° C. as minimum value for the first temperature.

The foam thus prepared is finally transferred into the vessel connected to the inlet device (reference numeral 100 in the figures). This vessel may comprise customary vessels known in the technical field, for example silos for solids or containers.

It is also conceivable to conduct the above-described preparatory steps at a site spatially separate from the side of the chemolysis. In that case, the prepared foam is filled into suitable transport vehicles, for example silo vehicles, for further transport. For further transport, the prepared foam may additionally be compressed in order to achieve a higher mass-to-volume ratio. At the site of the chemolysis reactor, the foam is then filled into the vessel. It is also conceivable to connect the transport vehicle used directly to the inlet device, in which case the transport vehicle should be regarded as a vessel within the terminology of the present invention.

### Chemolysis of the Polyurethane Foam

Step (B) of the method according to the invention includes the chemolysis of the polyurethane foam provided in step (A). This step is in a chemolysis apparatus having
(i) an inlet device (reference numeral 200 in the figures),
(ii) a chemolysis reactor connected to the inlet device (reference numeral 300 in the figures),
(iii) an outlet device connected to the chemolysis reactor (reference numeral 400 in the figures) and
(iv) at least one gas removal device (reference numeral 500 in the figures) for removal of the compounds present in the cell structure.

Step (B) comprises the following partial steps: (B.I), the introducing of the polyurethane foam from the vessel into the inlet device and thence into the chemolysis reactor, where the polyurethane foam is degassed before being contacted with the chemolysis reagent by
(α) removing at least oxygen (i.e. (i) the oxygen present in component X and (ii) any oxygen formed by decomposition reactions of constituents of component X), but preferably all constituents of component X or gaseous decomposition products thereof, from the chemolysis apparatus at a pressure of not more than 960 mbar_{(abs.)} and a temperature of not more than 120° C. in gaseous form via the gas removal device,
   so as to obtain a degassed polyurethane foam, (B.II), the reacting of the degassed polyurethane foam in the chemolysis reactor with a chemolysis reagent in the presence of a catalyst in an inert gas atmosphere to obtain a (first) product mixture, and (B.III) the discharging of the (first) product mixture from the chemolysis reactor through the outlet device.

In the course of step (B.I), the polyurethane foam is degassed, i.e. the volatile accompanying substances present in the cell structure are removed from the cells and/or the lamellas of the cell structure of the polyurethane foam and are discharged via the at least one gas outlet device (500). There are various ways of achieving this:

In a first variant of step (B.I), which forms part of the first alternative solution and is illustrated in FIG. 1, the vessel (100 in FIG. 1) and/or the inlet device (not shown in FIG. 1, but likewise possible) is provided with an internal flexible lining (600) which is collapsed in the first step by adjusting the first pressure (p1) to a value in the range from 0.1 mbar_{(abs.)} to 100 mbar_{(abs.)} and hence the polyurethane foam is compressed, and which is expanded again in the second step by supplying an inert gas (3) to establish the second pressure (p2). The second pressure is preferably not more than 1.8 bar_{(abs.)} and especially corresponds to ambient pressure (i.e. the second step involves expansion to ambient pressure). “M” here and in the other figures stands for motor and denotes a motor-driven device, in the present case a device for opening and closing entry into and exit from the vessel (100).

FIG. 1 shows, on the left, the filling of the vessel (100) with polyurethane foam (1). The valve in the lower region of the vessel (110), the connection to inlet device (200) and the gas removal device (500; valve 510 in “closed” position) are closed.

Shown in the middle of FIG. 1 is the performance of the first step. The introduction opening of the vessel (100), the valve 110 and the connection to the inlet device (200) are closed. The gas removal device (500) is used to apply a reduced pressure (valve 510 in “open” position), and the pressure within the flexible lining (600) is reduced to p1.

FIG. 1 shows, on the right, the second step, and the conveying of the degassed polyurethane foam (2) into the inlet device (200) which follows the second step. The pressure within the flexible lining is increased to p2 in the second step by adding an inert gas (3) through the valve 110 which is now open. After opening the connection to the inlet device, the degassed polyurethane foam (2) is conveyed to the inlet device (200) (i.e. simply falls downward into it under gravity).

Preferably, in the first variant, no deliberate change in temperature is undertaken at the transition from the first to the second step, such that the temperature of the steps is in the range from −20° C. to 120° C. Preferably, both the first step and the second step are conducted at a temperature in the range from 0° C. to 80° C. If the compounds to be removed are liquids under standard conditions (which does not mean that there cannot be a significant vapor pressure), a lower temperature limit of 16° C. has been found to be useful. It has been found to be advantageous to repeat the first step and second step, especially twice to 5 times, before the polyurethane foam thus degassed is sent to the reaction in step (B.II).

The flexible lining used in this variant is preferably a film/foil of polyethylene, polypropylene, aluminum, polyvinylchloride, polyetheretherketone, polystyrene, polycarbonate, polyester, polyethylene terephthalate or a composite of the aforementioned materials.

The lowering of the pressure in the first step to a maximum of 100 mbar_{(abs.)} causes the flexible lining to collapse and compresses the polyurethane foam. This pushes volatile accompanying substances out of the cell structure of the foam and discharges them via the gas removal device. After the second pressure has been established by supplying an inert gas (especially nitrogen, argon or helium), the degassed polyurethane foam may be conveyed to the chemolysis reactor by vibration, mechanically or pneumatically, or else simply under gravity. In this variant, the chemolysis reagent and the catalyst are added only after the polyurethane foam has left the region of the chemolysis reactor provided with the flexible lining; in particular, the chemolysis reagent and the catalyst are added only in the chemolysis reactor. The chemolysis reagent is preferably added at a temperature which is especially higher than the first temperature and is preferably in the range from 120° C. to 240° C.

In a second variant of step (B.I), which also forms part of the first alternative solution and which is illustrated in FIG. 2a,b, the inlet device has a first lock region (121) (upstream of the chemolysis reactor), having a closable feed device for the polyurethane foam (1) provided in step (A) and a closable removal device for the degassed polyurethane foam (2),

wherein step (B.I) includes the following steps:
(B.I.1.a) closing the removal device of the first lock region, introducing polyurethane foam into the first lock region and closing the feed device of the first lock region;
(B.I.2.a) performing the first step of (B.I) in the first lock region with adjustment of the first pressure to a value in the specified range from 0.1 mbar_{(abs.)} to 100 mbar_{(abs.)};
(B.I.3.a) performing the second step of (B.I) in the first lock region with adjustment of the second pressure to a value in the specified range from >p1 to 2.0 bar_{(abs.)} by supplying an inert gas to obtain degassed polyurethane foam;
(B.I.4.a) transferring the degassed polyurethane foam obtained in (B.I.3.a) into the chemolysis reactor.

In the simplest configuration of this embodiment, there is only one lock region; the wording “first lock region” thus does not necessarily imply the obligatory presence of multiple lock regions.

However, the use of at least two lock regions, by means of alternating operation thereof, opens up the option of continuous transfer of polyurethane foam into the chemolysis reactor. In this embodiment of the second variant of the invention, the inlet device, in addition to the first lock region, has a second lock region having a closable feed device for the polyurethane foam provided in step (A) and a closable removal device for the degassed polyurethane foam,

wherein a first portion of the polyurethane foam is introduced into the first lock region in step (B.I.1.a), wherein step (B.I) additionally includes the following steps:
(B.I.1.b) closing the removal device of the second lock region, introducing a second portion of the polyurethane foam into the second lock region and closing the feed device of the second lock region;
(B.I.2.b) performing the first step of (B.I) in the second lock region with adjustment of the first pressure to a value in the specified range from 0.1 mbar_{(abs.)} to 100 mbar_{(abs.)};
(B.I.3.b) performing the second step of (B.I) in the second lock region with adjustment of the second pressure to a value in the specified range from >p1 to 2.0 bar_{(abs.)} by supplying an inert gas to obtain a second portion of the degassed polyurethane foam;
(B.I.4.b) transferring the second portion of the degassed polyurethane foam into the chemolysis reactor;
   wherein steps (B.I.1.a) to (B.I.4.a) are matched to steps (B.I.1.b) to (B.I.4.b) such that degassed polyurethane foam (2) is transferred continuously into the chemolysis reactor.

The left-hand half of FIG. 2a shows a lock (220) with a first (221) and a second lock region (222). The second lock region (222) is of the same construction as the first; this is not shown specifically in the figure. The access to the second lock region (222) is closed. Polyurethane foam (1) is just being introduced into the first lock region (221). The first lock region (221) is closed in the downward direction (i.e. toward the chemolysis reactor). After the filling operation has ended, as shown in the right-hand half of FIG. 2a, the entry to the first lock region (221) is closed. The valve (510) belonging to the gas removal device (500) is opened and pressure p1 is established by lowering the pressure (first step). In parallel, polyurethane foam (1) can be introduced into the second lock region (222). On attainment of pressure p1 in the first lock region (221), the valve 510 is closed and pressure p2 is established by adding an inert gas (3) via valve 210 (left-hand half of FIG. 2b). Chemolysis reagent can likewise be fed in via valve 210. On attainment of pressure p2, valve 210 and 510 are closed, and the now degassed and optionally chemolysis reagent-wetted polyurethane foam (2) can be conveyed further to the chemolysis reactor (right-hand half of FIG. 2b).

With regard to the temperatures and pressures, the statements made above for the first variant are correspondingly also applicable to the second variant.

In this variant, the chemolysis reagent can be added to the polyurethane foam not just in the chemolysis reactor, but also immediately after the second step (i.e. after the degassing operation has ended), i.e. still within the first and/or second lock region. The added chemolysis reagent in both cases is at a temperature which is especially higher than the first temperature and is preferably in the range from 120° C. to 240° C. It is likewise possible to add the catalyst at this early stage (especially as a solution in the chemolysis reagent). In the case of addition of the chemolysis reagent at the early stage of the first and/or second lock region, the polyurethane foam is preferably wetted therewith. The additions of chemolysis reagent at the early stage of the first and/or second lock region does not of course mean that no further chemolysis reagent and/or further catalyst is added in the chemolysis reactor.

In this variant, the polyurethane foam can be introduced into the first or second lock region by vibration, mechanically or pneumatically. The lock region is filled with the polyurethane foam and is then closed. Vacuum is applied, and the air outlet valve is then closed again. The lowering of the pressure in the first step to a maximum of 100 mbar_{(abs.)} causes volatile components to be sucked out of the cell structure of the foam and discharged via the gas outlet device. After the second pressure has been established by supplying an inert gas (especially nitrogen, argon, or helium), the degassed polyurethane foam may be conveyed to the chemolysis reactor. This can in turn be accomplished by vibration, mechanically or pneumatically, or else simply as a result of gravity. In the case of contacting of the polyurethane foam with chemolysis reagent at the early stage of the first or second lock region, there is an increase in the apparent density of the polyurethane foam, as a result of which it can easily drop downward into the reactor. Moreover, it is made easier for the polyurethane foam to be mixed into chemolysis reagent already present in the chemolysis reactor if the cell structure of the polyurethane foam already contains chemolysis reagent.

In a third variant of step (B.I), which likewise forms part of the first alternative solution and which is illustrated in FIG. 3, the polyurethane foam, during the first step of (B.I), with adjustment of the first pressure (p1) to a value within the specified range from 0.1 mbar_{(abs.)} to 100 mbar_{(abs.)}, is conveyed through and comminuted in a device for mechanical comminution (230) disposed in a first portion of the inlet device (201), in which case the second step is conducted in such a way that the polyurethane foam (11) after the mechanical comminution is conveyed through a second portion of the inlet device (202), downstream of the first portion, into an inert gas atmosphere (especially in a nitrogen, argon or helium atmosphere) under the second pressure. This conveying can be effected by means of (at least) a screw shaft, (at least) a piston, (at least) a conveyor belt, vibration and/or gravity.

The device for mechanical comminution (230) may, for example, be a cutting mill, a knife mill, an impact cup and/or a hammer mill. The use of an impact cup or a hammer mill is preferred especially when the polyurethane foam is introduced into the chemolysis apparatus in a frozen state. This is because this embodiment in particular of the third variant of the present invention permits at least partial incorporation of the mechanical comminution of the polyurethane foam, which is preferably conducted, into step (B). In that case, the mechanical comminution of the polyurethane foam in step (A) as described further up can be restricted to a coarse comminution of the polyurethane foam into pieces of manageable size, or even be dispensed with entirely.

Apart from the above-described embodiment with freezing of the polyurethane foam, the statements made for the first and second variants with regard to temperatures and pressures are correspondingly also applicable to the third variant. In this embodiment of the third variant too, the pressures are preferably as described for the first and second variants, but the mechanical compression is naturally effected at a lower temperature than 0° C., especially at temperatures of down to −20° C.

As in the second variant, it is also possible in the third variant for the chemolysis reagent to be added to the polyurethane foam not just in the chemolysis reactor, but also immediately after the second step (i.e. after the degassing operation has ended), i.e. here still within the second portion of the inlet device. The added chemolysis reagent in both cases is at a temperature which is especially higher than the first temperature and is preferably in the range from 120° C. to 240° C. It is likewise possible to add the catalyst at this early stage (especially as a solution in the chemolysis reagent). In the case of addition of the chemolysis reagent at the early stage of the second portion of the inlet device, the polyurethane foam is preferably wetted therewith. The additions of chemolysis reagent at the early stage of the second portion of the inlet device does not of course mean that no further chemolysis reagent and/or further catalyst is added in the chemolysis reactor.

In that variant, the polyurethane foam is guided by means of a conveyor—preferably one that is sealed as far as possible, especially a screw conveyor, to the device for mechanical comminution, which is under a pressure of not more than 100 mbar_{(abs.)}, wherein volatile compounds are largely removed during the mechanical comminution by the compression operations in the comminution. By conveying the polyurethane foam thus comminuted into the second portion of the inlet device under an inert gas atmosphere, the cell structure of the polyurethane foam is filled with the inert gas and hence effectively protect against the penetration of other gases. The mechanical comminution in step (B.I) may possibly replace a mechanical comminution in step (A).

In a fourth variant of step (B.I), which constitutes the second alternative solution and which is illustrated in FIG. 4, the polyurethane foam is conveyed during the first step to a device for mechanical compression (240) which is disposed in the inlet device, wherein the polyurethane foam is compressed in the second step in said device for mechanical compression at a value for the second pressure p2 in the range from 5 bar_{(abs.)} to 200 bar_{(abs.)}. The pressure p2 can be determined by means of a manometer (connected to a capillary that projects into the region of the inlet device in which the device for mechanical compression is disposed). Inertization of the polyurethane foam before the mechanical compression is preferred, but not obligatory. After passing through the second step, the pressure is thus at least 5 bar_{(abs.)}, which is higher than the pressure preferred for step (B.II) (in this regard, see the remarks further down). The expansion to the pressure of step (B.II) is preferably effected on entry of the polyurethane foam treated in step (B.I) into the chemolysis reactor. Chemolysis reagent (4), in this variant, for example, can be added after passage through the device for mechanical compression (i.e. after the degassing operation has ended) and before entry into the chemolysis reactor (300) (see further down for further details).

In this variant, the gas removal device (500) is preferably disposed within the inlet device (220). In the chemolysis reactor (300), there may be disposed a device (600) for discharge of reaction gases formed during the chemolysis, such as carbon dioxide in particular.

An example of a suitable device for mechanical compression is an extruder (also including multizone screws and single- and multi-shaft extruders), a roller or a piston. Multizone screws are extruders wherein the spirals have, for example, different diameters or slopes of the spiral windings. This promotes compression.

As in the second and third variants, it is also possible in the fourth variant for the chemolysis reagent to be added to the polyurethane foam not just in the chemolysis reactor, but also immediately after the second step (i.e. after the degassing operation has ended), i.e. here still within the inlet device, but after passing through the device for mechanical compression. The added chemolysis reagent in both cases is at a temperature which is preferably in the range from 120° C. to 240° C., especially in the range of >120° C. to 140° C. By contrast with the second and third variants, however, it is preferable not to add any catalyst yet at this point. In the case of addition of the chemolysis reagent at the early stage of the inlet device, the polyurethane foam is preferably wetted therewith. The additions of chemolysis reagent at the early stage of the inlet device does not of course mean that no further chemolysis reagent and/or further catalyst is added in the chemolysis reactor.

As in the other variants, the temperature for the second step is preferably in the range from −20° C. to 120° C. and especially corresponds to the first temperature (i.e. no deliberate change in temperature is undertaken at the transition from the first of the second step). The first temperature is preferably in the range from 0° C. to 80° C. This is also applicable to the second temperature. If the compounds to be removed are liquids under standard conditions (which does not rule out a significant vapor pressure), a lower temperature limit of 16° C. has been found to be useful (in both steps).

In the device for mechanical compression which is used in this variant, the polyurethane foam is compressed, which pushes out gases and volatile compounds present in the cell structure of the polyurethane foam.

In step (B.II) of the method according to the invention, the actual chemical recycling takes place, the cleavage of the urethane bonds (which does not mean that the reaction cannot partly commence at the early stage of the inlet device, provided that the degassing is complete; see the above remarks relating to step (B.I)). The chemolysis is conducted in an inert gas atmosphere (especially in a nitrogen, argon or helium atmosphere). The chemolysis reagent used is preferably also saturated freed of oxygen by inert gas saturation (regardless of whether this is being added for the first time in the chemolysis reactor or at the early stage of the inlet device).

Step (B.II) may in principle be conducted by any of the methods known in the specialist field. In order to perform the reaction, the chemolysis reactor in particular is partly filled with chemolysis reagent (and catalyst). The polyurethane foam to be converted is introduced into this “bath” of chemolysis reagent. Introduction of the polyurethane foam is possible either above or below the liquid level.

Preferred configurations of this step are alcoholysis (usually referred to in the literature as glycolysis; cf. no. 2 further up) and hydroalcoholysis (usually referred to in the literature as hydroglycolysis; cf. no. 3 further up). Irrespective of the specific manner of configuration, step (B.II) is conducted at a temperature range from 140° C. to 240° C., preferably 160° C. to 240° C., more preferably 180° C. to 220° C. The pressure in step (B.II) is preferably >960 mbar_{(abs.)} to 1.8 bar_{(abs.)} and is especially equal to ambient pressure (i.e. the reaction in step (B.II) is especially unpressurized). The pressure in step (B.II) means the pressure prevailing in the gas space of the chemolysis reactor.

If the chemolysis is executed as an alcoholysis, the chemolysis reagent (an alcohol in this case) is added without the addition of significant proportions of water. What is meant by without the addition of significant proportions of water in this connection is that water is not deliberately added in such amounts that would result in a significant degree of hydroalcoholysis. This does not rule out the introduction of small amounts of water that are in dissolved form, for instance, in the alcohol used in step (B.II) and are introduced via the polyurethane foam or may be used as solvent for the catalyst.

If the chemolysis is executed as a hydroalcoholysis, the chemolysis reagent used is an alcohol and water, in which case these two components may but need not be premixed. In particular, it is also possible first to add solely the alcohol (and a small portion of the water at most) and to dissolve the polyurethane foam therein, before the water (or the rest of the water) is added. In the hydroalcoholysis, it is preferable not to add the whole amount of water used all at once, but to add it gradually, at the rate at which water is chemically consumed in the reaction.

Irrespective of whether the chemolysis is performed as an alcoholysis or as a hydroalcoholysis, the chemolysis reagent preferably comprises an alcohol selected from ethylene glycol, diethylene glycol, propylene glycol, dipropylene glycol, methyl glycol, triethylene glycol, glycerol, 2-methylpropane-1,3-diol or a mixture of two or more of the aforementioned alcohols. Particular preference is given to diethylene glycol.

Even though alcoholysis and hydroalcoholysis are preferred, it is of course likewise possible to use other chemolysis methods such as hydrolysis or aminolysis.

Suitable catalysts for step (B.II) are especially an alkali metal hydroxide, an alkaline earth metal hydroxide, an alkali metal salt of a carboxylic acid (especially an acetate), an alkaline earth metal salt of a carboxylic acid (especially an acetate), a Lewis acid (especially dibutyltin dilaurate, tin octoate, monobutyltin oxide or tetrabutyl titanate) and/or an organic amine (especially diethanolamine, 1,1,3,3-tetramethylguanidine, 1,8-diazabicyclo(5.4.0)undec-7-ene or 1,4-diazabicyclo[2.2.2]octane). The catalyst is added no later than in the chemolysis reactor; it may alternatively (see the above remarks) already have been added beforehand in the inlet device, especially dissolved in the chemolysis reagent.

Step (B.II) may be conducted in any reactor known for such a purpose in the specialist field. Especially suitable chemolysis reactors are stirred tanks (stirred reactors) and tubular reactors.

Step (B.II) gives a first product mixture containing unconverted chemolysis reagent (since it was used in a superstoichiometric amount), polyols (originating from the polyol component and/or newly formed as degradation products in the reaction with the chemolysis reagent), and carbamates and/or amines (depending on the chemolysis reagent used). The excess chemolysis reagent, in the preferred embodiments with performance of the chemolysis as alcoholysis or hydroalcoholysis, comprises at least the alcohol used in the chemolysis, with or without water (in the case of performance of the chemolysis as hydroalcoholysis). Water may additionally also be present in a small amount in the case of performance of chemolysis as pure alcoholysis; see the above remarks.

This first product mixture is discharged from the chemolysis reactor in step (B.III) and then sent to further workup (step (C), preferably step (C) and step (D)). The discharge device to be used for this purpose may be any of the devices known in the specialist field for fluid conveying, such as pumps in particular.

### Recovery of the Polyols

In step (C) of the method according to the invention, the first product mixture obtained in step (B) is worked up to obtain the polyols. This workup can in principle be accomplished as known in the prior art. Preferably, the first product mixture is first admixed with an organic solvent. There are various possible configurations available for this purpose:

In one possible configuration of step (C), in the preferred embodiments with performance of the chemolysis as alcoholysis or hydroalcoholysis, this comprises the steps of:
(C.I) combining the first product mixture obtained in step (B.III), especially without prior removal of any water present in the first product mixture, with an organic solvent which is not fully miscible with the alcohol used in step (B) (especially an aliphatic hydrocarbon, an alicyclic hydrocarbon, an aromatic hydrocarbon or a mixture of two or more of the aforementioned organic solvents), and separating the phases into a first alcohol phase and a first solvent phase;
(C.II) working up the first solvent phase to recover the polyols.

Step (C.II) comprises workup steps that are known to the person skilled in the art, such as washing and distilling in particular.

In another possible configuration of step (C), in the preferred embodiments with performance of the chemolysis as alcoholysis or hydroalcoholysis, this comprises the steps of:
(C.I*) mixing the first product mixture obtained in step (B.III) with an organic solvent which is miscible with the alcohol used in step (B) (especially a halogen-substituted aliphatic hydrocarbon, a halogen-substituted alicyclic hydrocarbon, a halogen-substituted aromatic hydrocarbon or a mixture of two or more of the aforementioned organic solvents), optionally followed by a removal of solid constituents, to obtain a second product mixture;
(C.II*) washing the second product mixture obtained in step (C.I*) with an aqueous wash liquid (with partial hydrolysis of any carbonates present in the second product mixture to release amines and alcohol), and separation of the phases into a first solvent phase containing organic solvent used in step (C.I*) and polyols, and
   a first aqueous phase containing water, alcohol, carbamates and amines;
(C.III*) working up the first solvent phase to obtain the polyols.

Step (C.III*) again comprises workup steps that are known to the person skilled in the art, such as washing and distilling in particular.

Extraction of the first product mixture with an organic solvent can of course also be performed in the case of performance of the chemolysis as a pure hydrolysis.

### Recovery of the Amines

The method according to the invention preferably comprises a step (D) for recovery of at least one amine corresponding to an isocyanate of the isocyanate component. The starting point for that part of the workup is the alcohol phase or first aqueous phase recovered from the first product mixture in step (C).

The manner of performance of step (D) depends especially on the manner of performance of step (B.II). If step (B) is performed as an alcoholysis, the first alcohol phase or first aqueous phase will regularly still contain substantial proportions of carbamates that have to be hydrolyzed in step (D). Such a hydrolysis is advantageously conducted catalytically, suitable catalysts being the same as described above for the chemolysis.

If step (B.II) is performed as a hydroalcoholysis, there are already no carbamates any longer at this point in the process (or at least there are insignificant trace contents), and so a separate hydrolysis step is dispensable.

Irrespective of this, step (D) comprises workup steps, such as a distillation in particular, in order to purify the amine obtained by the cleavage of the urethane bonds. It is particularly advantageous here to incorporate the isolation from a polyurethane foam of recovered amines into a process for preparing new amine, as described in WO 2020/260387 A1 and as yet unpublished patent application PCT/EP2021/075916.

The invention is more particularly elucidated hereinafter with reference to examples.

### EXAMPLES

### Example 1 (According to the Invention, First Variant)

250 g of polyurethane flakes (tolylene diisocyanate-based flexible foam) was introduced into a flexible polyethylene (PE) bag (30 L), which was closed and connected to a vacuum pump. By starting the vacuum pump, the pressure within the PE bag was reduced to a value of below 10 mbar_{(abs.)}. Subsequently, the interior of the PE bag was expanded to ambient pressure by adding nitrogen. This operation was repeated twice more. Subsequently, an oxygen probe was placed into the outlet of the bag. Exertion of pressure on the inertized bag resulted in a flow of the gas present therein past the oxygen probe for 1 min. At no time did the oxygen content in the output air exceed 0.5% by weight.

Subsequently, the inertized foam flakes were used to conduct a glycolysis as follows:

An additional charge of 250 g of diethylene glycol and 2.5 g of bismuth trineodecanoate in a 1 L 3-neck round-bottom flask was heated up to 200° C. Subsequently, the polyurethane flakes were added, dissolved, and kept at 200° C. for a further 3 h. During the addition and reaction, a constant nitrogen purge was switched on (at 10 NL/h). After the reaction time, the mixture was cooled down to room temperature.

### Example 2 (Comparative Experiment)

The chemolysis of polyurethane flakes was conducted analogously to example 1, but without the degassing according to the invention. Here too, a nitrogen purge was connected constantly during the metered addition and reaction.

In example 2, distinct blackening of the reaction mixture was apparent, whereas the previously degassed polyurethane foam (example 1) showed merely a pale brown color. This unambiguously shows the influence of the oxygen present in the cell structure of the polyurethane foam by virtue of distinctly enhanced oxidation of the tolylenediamine compounds released during the glycolysis.

1. A method of recovering raw materials from a polyurethane foam which is based on an isocyanate component and a polyol component and has a cell structure comprising a component X selected from the group consisting of oxygen, a blowing agent, a disinfectant or a mixture of two or more thereof, wherein component X comprises at least oxygen, by reacting the polyurethane foam with a chemolysis reagent, said method comprising:
(A) providing the polyurethane foam in a vessel;
(B) chemolyzing the polyurethane foam in a chemolysis apparatus comprising (i) an inlet device, (ii) a chemolysis reactor connected to the inlet device, (iii) an outlet device connected to the chemolysis reactor, and (iv) a gas removal device disposed in the vessel and/or in the inlet device,
wherein the chemolysis comprises:
(B.I) introducing the polyurethane foam from the vessel into the inlet device and then into the chemolysis reactor, where the polyurethane foam is degassed before being contacted with the chemolysis reagent by
(α) removing at least oxygen from the chemolysis apparatus at a pressure of not more than 960 mbar_{(abs.)} and a temperature of not more than 120° C. in gaseous form via the gas removal device,
so as to obtain a degassed polyurethane foam;
(B.II) reacting the degassed polyurethane foam in the chemolysis reactor with a chemolysis reagent in the presence of a catalyst in an inert gas atmosphere to obtain a product mixture;
(B.III) discharging the product mixture from the chemolysis reactor through the outlet device; followed by:
(C) recovering a polyol; and
(D) optionally, recovering an amine corresponding to an isocyanate from the isocyanate component.

2. The method as claimed in claim 1, in which the degassing of the polyurethane foam in (B.I) is conducted by a process comprising:
(1) subjecting the polyurethane foam in a first step, at a first temperature in the range from −20° C. to 120° C., to a first pressure in the range from 0.1 mbar_{(abs.)} to 100 mbar_{(abs.)}, and
(2) subjecting the polyurethane foam in a second step, by supplying an inert gas, to a second pressure which is greater than the first pressure and is not more than 2.0 bar_{(abs.)}.

3. The method as claimed in claim 2, in which the vessel and/or the inlet device is provided with an internal flexible lining which is collapsed in the first step by establishment of the first pressure that compresses the polyurethane foam, wherein the internal flexible lining is thereafter expanded in the second step by supply of the inert gas.

4. The method as claimed in claim 2, in which the inlet device comprises at least a first lock region having a closable feed device for the polyurethane foam provided in step (A) and a closable removal device for the degassed polyurethane foam,
wherein step (B.I) comprises:
(B.I.1.a) closing the removal device of the first lock region, introducing the polyurethane foam into the first lock region and closing the feed device of the first lock region;
(B.I.2.a) performing the first step of (B.I) in the first lock region;
(B.I.3.a) performing the second step of (B.I) in the first lock region by supplying the inert gas to obtain degassed polyurethane foam; and
(B.I.4.a) transferring the degassed polyurethane foam obtained in (B.I.3.a) into the chemolysis reactor.

5. The method as claimed in claim 4, in which the inlet device further comprises a second lock region having a closable feed device for the polyurethane foam provided in step (A) and a closable removal device for the degassed polyurethane foam,
wherein a first portion of the polyurethane foam is introduced into the first lock region in step (B.I.1.a), such that a first portion of the degassed polyurethane foam is obtained in step (B.I.3a), wherein step (B.I) further comprises:
(B.I.1.b) closing the removal device of the second lock region, introducing a second portion of the polyurethane foam into the second lock region and closing the feed device of the second lock region;
(B.I.2.b) performing the first step of (B.I) in the second lock region;
(B.I.3.b) performing the second step of (B.I) in the second lock region by supplying the inert gas to obtain a second portion of the degassed polyurethane foam; and
(B.I.4.b) transferring the second portion of the degassed polyurethane foam into the chemolysis reactor;
wherein steps (B.I.1.a) to (B.I.4.a) are matched to steps (B.I.1.b) to (B.I.4.b) such that degassed polyurethane foam is transferred continuously into the chemolysis reactor.

6. The method as claimed in claim 2, in which the polyurethane foam is conveyed during the first step of (B.I) through a device for mechanical comminution which is disposed in a first portion of the inlet device and is comminuted, wherein the second step is conducted in such a way that the polyurethane foam after the mechanical comminution is conveyed through a second part, downstream of the first part, of the inlet device into an inert gas atmosphere under the second pressure.

7. The method as claimed in claim 2, in which the second pressure is not more than 1.8 bar_{(abs.)}.

8. The method as claimed in claim 1, in which the degassing of the polyurethane foam in (B.I) is conducted by a process comprising:
(1) conveying the polyurethane foam, in a first step at a first temperature in the range from −20° C. to 120° C. and a first pressure in the range from 0.1 mbar_{(abs.)} to 960 mbar_{(abs.)} to a device for mechanical compression which is disposed within the inlet device, wherein the gas removal device is upstream of the device for mechanical compression,
and
(2) compressing the polyurethane foam, in a second step, in the device for mechanical compression at a second pressure in the range from 5 bar_{(abs.)} to 200 bar_{(abs.)}.

9. The method as claimed in claim 8, in which the gas removal device is disposed within the inlet device.

10. The method as claimed in claim 2, in which the second step is conducted at a second temperature of −20° C. to 120° C.

11. The method as claimed in claim 2, in which the component X comprises a constituent which is liquid at a temperature of 0° C. and a pressure of 1.000 bar_{(abs.)}, and in which the first temperature is at least 16° C.

12. The method as claimed in claim 1, in which step (B.II) is conducted at a temperature of 140° C. to 240° C.

13. The method as claimed in claim 1, in which
the blowing agent comprises pentane, a hydrochlorofluorocarbon, dichloromethane or a mixture of two or more thereof; and
the disinfectant comprises hydrogen peroxide, chlorine dioxide, formaldehyde, peracetic acid, an alkali metal hypochlorite, ethanol, isopropanol, 1-propanol, or a mixture of two or more thereof.

14. The method as claimed in claim 1,
in which the isocyanate component comprises tolylene diisocyanate, a di- and/or polyisocyanate from the diphenylmethane series, pentane 1,5-diisocyanate, hexamethylene 1,6-diisocyanate, isophorone diisocyanate, xylene diisocyanate, or a mixture of two or more of the aforementioned isocyanates, and/or
in which the polyol component comprises a polyether polyol, a polyester polyol, a polyetherester polyol, a polyethercarbonate polyol, or a mixture of two or more thereof.

15. The method as claimed in claim 1, in which the chemolysis reagent comprises ethylene glycol, diethylene glycol, propylene glycol, dipropylene glycol, methyl glycol, triethylene glycol, glycerol, 2-methylpropane-1,3-diol, or a mixture of two or more thereof.

16. The process of claim 1, in which (α) comprises removing all constituents of component X or gaseous decomposition products thereof.
